(19) United States
(12) Patent Application Publication
(10) Pub. No.: US 2002/0138464 A1
(43) Pub. Date: Sep. 26, 2002

(54) Method and apparatus to index a historical database for efficient multiattribute SQL queries

(76) Inventor: David M. Calascibetta, Northbrook, IL (US)

Correspondence Address: John A. Franczyk, Butler, Rubin, Saltarelli & Boyd, 1800 First National Plaza, 70 West Madison Street, Chicago, IL, 60602, US

(21) Appl. No.: 09/816,261

(22) Filed: Mar. 26, 2001

(51) Int. Cl. G06F 7/00

(52) U.S. Cl. 707/1

(57) ABSTRACT

A method, apparatus, and article of manufacture for a multiple index combination system. A query is executed to access data stored on a data storage device connected to a computer. In particular, while accessing one or more single column indexes to retrieve partition invariant designators, multiple bit maps are generated and populated. As directed by the query predicate, the bit maps are combined into a single, global bit map. The global bit map directs the retrieval process to the required rows.

### BACKGROUND OF THE INVENTION

1. Field of the Invention

This invention relates in general to computer-implemented database systems, and, in particular, to executing complex SQL queries using inverted lists and dynamic bitmaps for any combination of conjunct and disjunct index operations.

2. Description of Related Art

Database Management Systems (DBMS) are utilized to store and retrieve computerized information. Relational Database Management Systems (RDBMS) utilize relationships among different types of data to store and retrieve that data. Relational database tables include rows (known in the industry as “tuples”) and columns of data. A database may have multiple tables, each of which will consist of multiple tuples and multiple columns. These tables are most commonly stored on direct access storage devices (DASD), including magnetic or optical disk drives for semi-permanent storage.

A database designer can organize a larger database table into several partitions, each of which will contain a portion of the table's data. Organizing a table into partitions enhances the speed and efficiency of searching and retrieving the data. Database designers will generally create and store partitions that contain more frequently-accessed on faster storage devices. Apportioning partitions over multiple DASD volumes improves and allows for faster parallel processing of data by placing each input/output data stream on a separate processing path. It also allows for better data availability and enables parallel processing of application and utility activities on multiple partitions.

Database access strategies require creation of an index, which is an ordered set of references to the tuples and records in the database. An index utilizes a key and a relative row location or number within a Partition Invariant Designator (known as a “PID”) to locate and access data within a partition. The PID is a function of the row number within a partition of a particular table, and the key is one of the fields of the record or one of the columns of a row. The key guarantees that each row is unique.

For direct access to the data, the index will be created to identify PIDs, and each data partition will have a unique index. When a user retrieves a PID from the index, the PID value will be assigned a corresponding position in a bitmap that is allocated to the associated column. Next, the bitmaps allocated to each column will be combined into a single bitmap using standard logic techniques and the resulting bitmap will control the data access method in retrieving the desired rows. Each bit in the bitmap corresponds positionally with the desired row within the partition. In previous art, filters are applied after the rows are retrieved to eliminate undesired rows, causing the database rows to be accessed unnecessarily. Therefore, there is a need in the art for improved index access that guarantees that rows are not retrieved unless requested.

Another major liability with the prior art is the requirement to construct many combinations of concatenated key indexes when query search patterns cannot be predetermined. This lack of predetermination characteristic is common in Decision Support Systems and Online Analytical Processing (OLAP) systems. Prior art creates a combinatorial explosion of index space many times the size of the data space. Therefore, there is also a need in the art for an index technique that does not require many combinations of (redundant) indexes to be created for undetermined search patterns.

Prior art requires some predetermined set of queries to be specified so that corresponding indexes can be constructed. Those skilled in the art will recognize that this requirement disallows users from composing their own queries, frequently eliminating the benefit of constructing the database. It may be true that 80% of the queries use only 20% of the constructed indexes, but it is the other 20% of the queries that may be most urgently useful. Unfortunately, to have all possibilities available, an index many times the size of the database is required, and in the case of large, historical databases, it is impossible to build all the necessary index combinations.

### SUMMARY OF A PREFERRED EMBODIMENT OF THE DISCLOSURE

To overcome the limitations in the prior art described above, and to overcome other limitations that will become apparent upon reading and understanding the present specification, an embodiment of the present invention discloses a method, apparatus, and article of manufacture for a computer-implemented dynamic index combination system.

In accordance with the present invention, a query is executed to access data stored on a data storage device connected to a computer. In particular, while accessing one or more indexes to retrieve row designators, bitmaps are allocated and populated dynamically. Before accessing the table rows, the dynamic bitmaps are combined as directed by the query predicate.

### BRIEF DESCRIPTION OF THE DRAWINGS

Referring now to the drawings in which like reference numbers represent corresponding parts throughout:

FIG. 1 illustrates an exemplary computer hardware environment that could be used in accordance with the present invention;

FIG. 2 is a flow diagram illustrating the steps performed by the bitmap generation and population system and the bitmap combination process.

FIG. 3 illustrates an exemplary base table space;

FIG. 4 is sample SQL illustrating the multiple indexes created on the base table.

FIG. 5 is sample SQL illustrating a demonstration query and a drawing of the associated parse tree for that query.

FIG. 6 is a flow diagram illustrating the retrieval process.

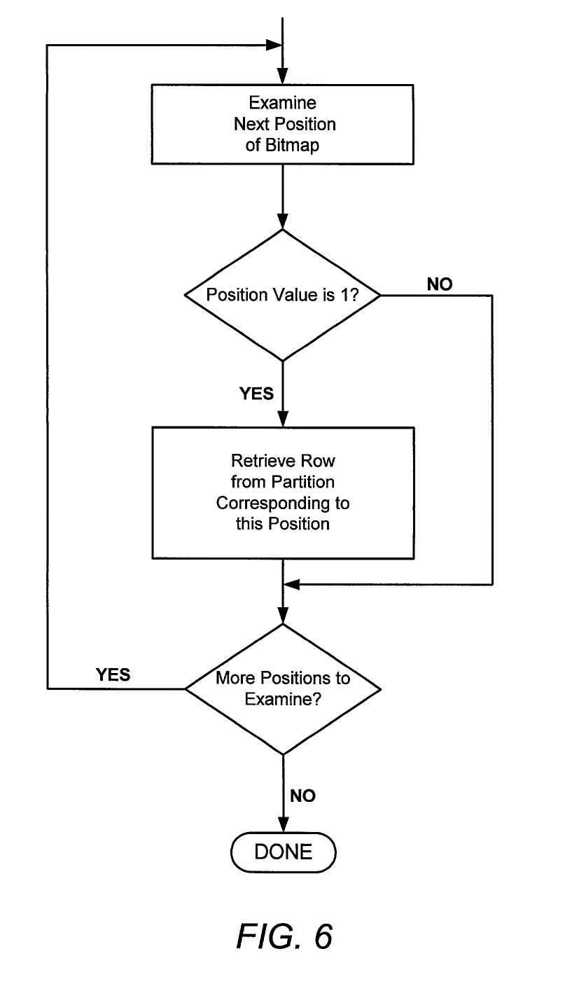

FIG. 7 is a flow diagram illustrating the bitmap generation process.

FIG. 8 is a sample bitmap contents and parse tree adjustments after the bitmap generation and population process.

FIG. 9 is a flow diagram for the bitmap combination process.

FIG. 10 is an example illustration of ANDing and ORing the bitmaps in the parse tree to produce the Global Bitmap.

FIG. 11 is a flow diagram of the row retrieval process using the Global Bitmap.

### DETAILED DESCRIPTION OF THE INVENTION

In the following description of the preferred embodiment, reference is made to the accompanying drawings which form a part hereof, and which is shown by way of illustration a specific embodiment in which the invention may be practiced. It is to be understood that other embodiments may be utilized as structural changes may be made without departing from the scope of the present invention.

Hardware Environment

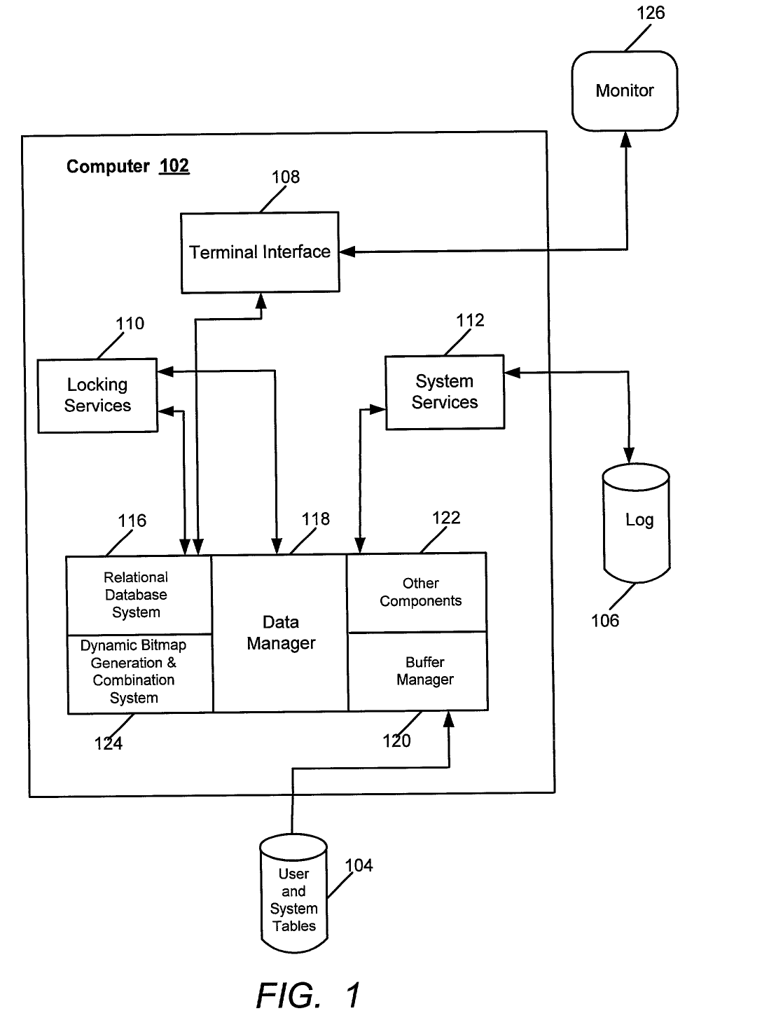

FIG. 1 illustrates a sample computer hardware environment that could be used with the present invention. In this sample environment, a computer system 102 includes one or more processing units connected to one or more data storage devices 104 and 106 that store one or more relational databases, such as a fixed or hard disk drive, a floppy disk drive, a CDROM drive, a tape drive, an optical storage device or other device.

Operators of the computer system 102 use a standard operator interface 108, to transmit information in the form of electronic signals to and from the computer system 102. The signals represent commands or “queries” to search and retrieve data from databases. In the present invention, these queries conform to the Structured Query Language (SQL) standard, and invoke functions performed by Relational DataBase Management System (RDBMS) software.

As illustrated in FIG. 1, the sample operating system includes three major components: the Internal Resource Lock Manager 110, the Systems Services module 112, and the Database Services module 114. The Internal Resource Lock Manager 110 is a locking service which allows data in a database system to be treated as a shared resource, thus allowing simultaneous access to the same data by any number of users. Data integrity within the database is maintained by concurrency control that are well-known to those experienced in the industry and the art. These same controls also isolate individual users. The Systems Services module 112 controls the total execution environment, including managing log data sets 106, gathering statistics, handling startup and shutdown, and providing management support.

The Database Services module 114 is at the focal point of the sample database management system. The Database Services module 114 is comprised of multiple submodules, including the Relational Database System (RDS) 116, the Data Manager 118, the Buffer Manager 120, a Dynamic Bitmap Generation and Combination System 124. The Database Services Module also frequently includes other components such as an SQL compiler/interpreter. These submodules support the functions of the SQL language, i.e. definition, access control, interpretation, compilation, database retrieval, and update of user and system data.

The SQL interface has evolved into a standard language for RDBMS software and has been adopted as such by both the American National Standards Institute (ANSI) and the International Standards Organization (ISO). The SQL interface allows users to formulate relational operations on the tables interactively, in batch files, or embedded in host languages, such as C and COBOL. SQL allows the user to manipulate the data.

In the preferred embodiment of the present invention, the RDBMS software comprises any relational database product manipulated by SQL, or any query language. Those skilled in the art will recognize, however, that the present invention has application to any RDBMS software, whether or not the RDBMS software uses SQL.

Generally, the RDBMS software and the instructions derived from that software will reside in a computer-readable medium, e.g. one or more of the data storage devices 104 and 106. Moreover, the RDBMS software and its corresponding instructions will, when read and executed by the computer system 102, cause the computer system 102 to perform the steps necessary to implement and/or use the present invention. An operating system will control, load and transfer the RDBMS software and its instructions from the data storage devices 104 and 106 into a memory of the computer system 102 for use during actual operations.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope of the present invention.

Those skilled in the art will recognize that the sample environment illustrated in FIG. 1 is not intended to limit the present invention. Indeed, those skilled in the art will recognize that other alternative hardware environments may be used without departing from the scope of the present invention.

Index Access and Bitmap Generation

An embodiment of the invention provides a dynamic bitmap generation and combination system. The bitmap generation and population process assigns bits corresponding to the Partition Invariant Designators (“PIDs”) while accessing an index. In particular, the bitmap generation and population process executes complex SQL queries using an index combining process for conjunct (e.g., “AND”) and disjunct (e.g., “OR”) index operations.

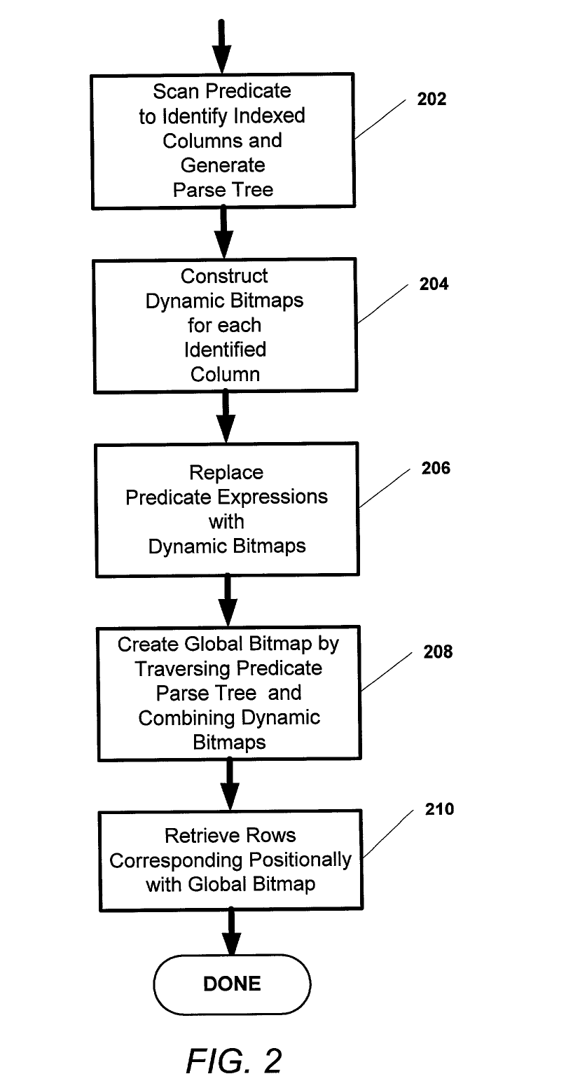

The entire apparatus is illustrated in the block diagram of FIG. 2. When the query arrives at the RDBMS the predicate must be scanned, or tokenized, and a parse tree is generated for the query predicate 202. For each column referenced in the parse tree, determine if the column has an index constructed on it. For each column with an associated index, construct a dynamic bitmap 204. Then, for each expression in the predicate for which a bit map exists, replace the expression with the bitmap 206. Traverse the parse tree combining the bit maps as indicated by the logical operators (AND and OR) connecting the expressions 208. Finally, begin row selection by retrieving rows corresponding positionally with the “1” values of the Global Bitmap 210. If the query is not fully indexed, apply the predicate represented by the parse tree as necessary to qualify the result rows.

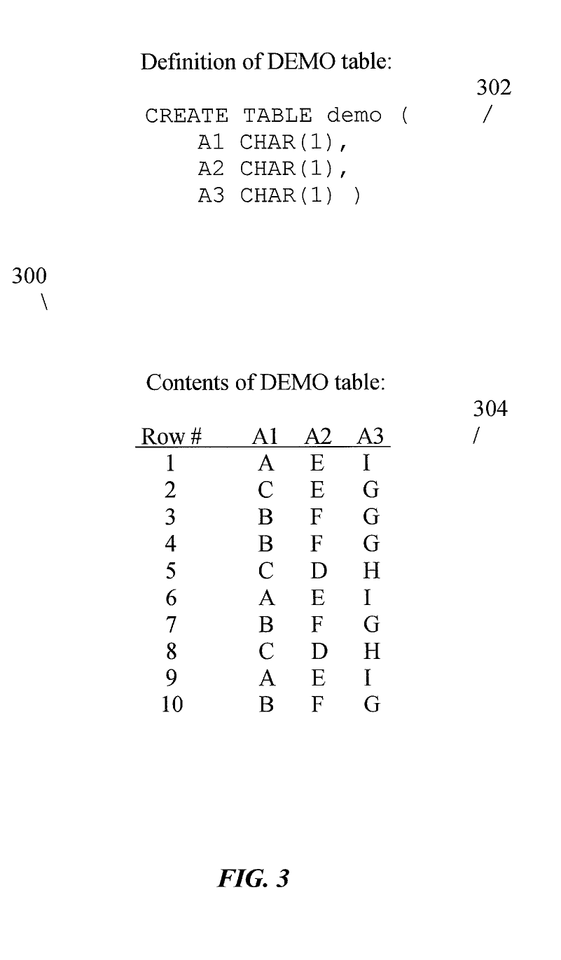

FIG. 3 illustrates an exemplary base table space 300. A base table space 300 contains a base table 302. The base table 302 is a table definition that logically contains rows and columns of data. For example, row 304 contains values for each column of the table. Multiple indexes 408 are created on the base table. The index 402 is used to quickly find a specific row in the partition of a table. In particular, the index 402 contains a single column value, such as value ‘A’, which contains the PID referencing that row. The set of distinct column values is used to index the base table 302.

In this invention, two processes precede accessing the rows within the table partitions:

Multiple bitmap generation and population

Combination of the plurality of bitmaps by ANDing or ORing as directed by the predicate to produce a single, global bitmap.

Another access technique is multiple indexes ANDing or ORing for multiple index access, which will be referred to as the “bitmap combination process” (BCP) for discussion purposes.

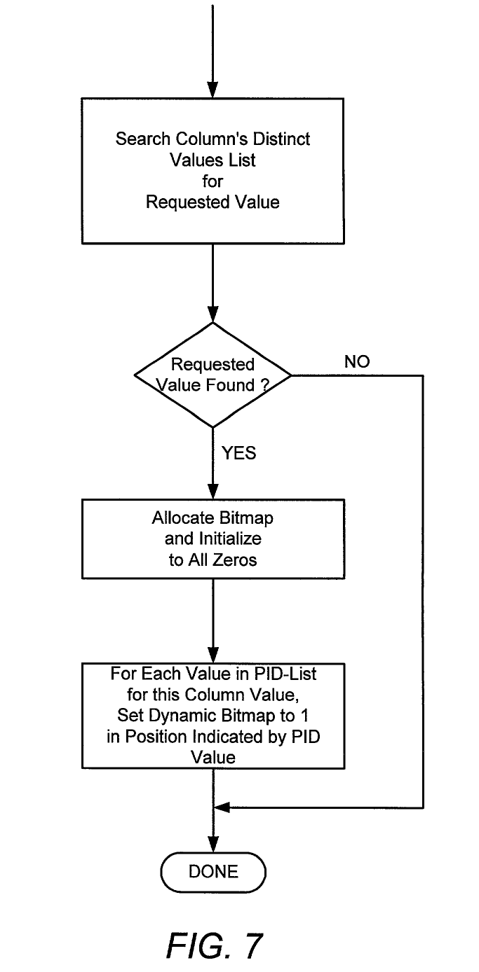

This bitmap combination process combines the results of the multiple bitmap generation and population process. For any query, the PIDs from each of the multiple, individual column indexes are retrieved into separate lists of PIDs. For each PID list, a bitmap is generated and populated by using the PID list values as a relative offset into the bitmap. For example, if the PID list contains the PID value “20”, the 20th position in the bitmap is turned on. This conversion process is illustrated in FIG. 7.

Dynamic bitmaps are efficient to create from the preferred embodiment of inverted lists indexes. Essentially, both represent the same information in slightly different formats. Inverted lists maintain a list of PIDs for each distinct value of the table's column. The bitmaps contain a bit array, with the array size equal to the number of rows in the partition. For each value that the query requests, the search for that value is made in the list of distinct values for the column. For each value qualified, the PID list is used to turn on bits corresponding to its relative row numbers in the list. For example, if distinct value ‘A’ is requested in the query, and that value exists in rows 1, 6, and 9 (of 10 rows) of the table, the inverted list looks like

A(3): 1, 6, 9

and the corresponding bitmaps looks like

A: 1000010010

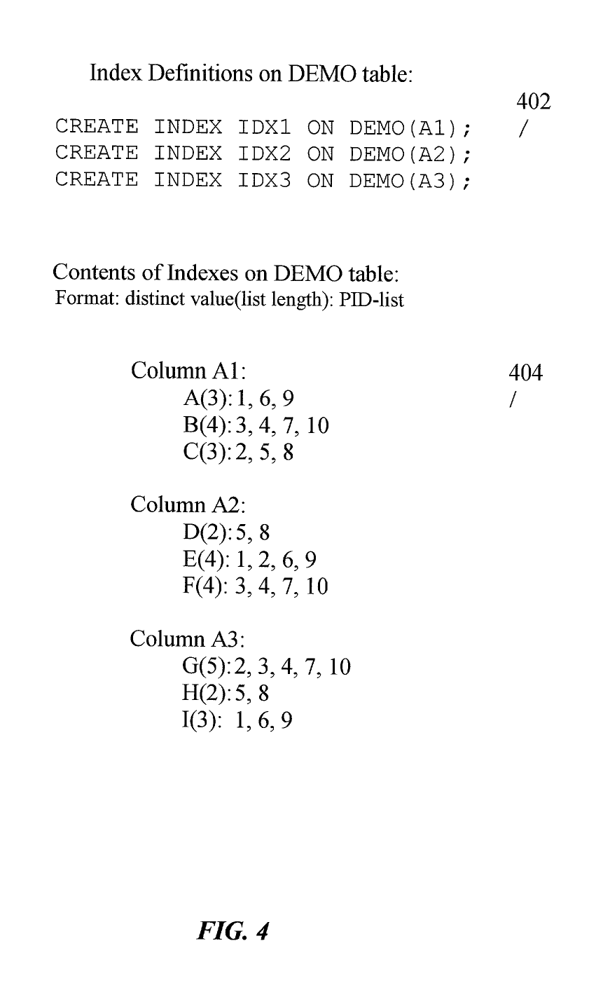

To illustrate construction of the dynamic bitmaps, we will create a simple table named DEMO, as illustrated in FIG. 3. FIG. 3 also illustrates that table DEMO contains 10 rows. An inverted list index is constructed on each column. These indexes are illustrated in FIG. 4.

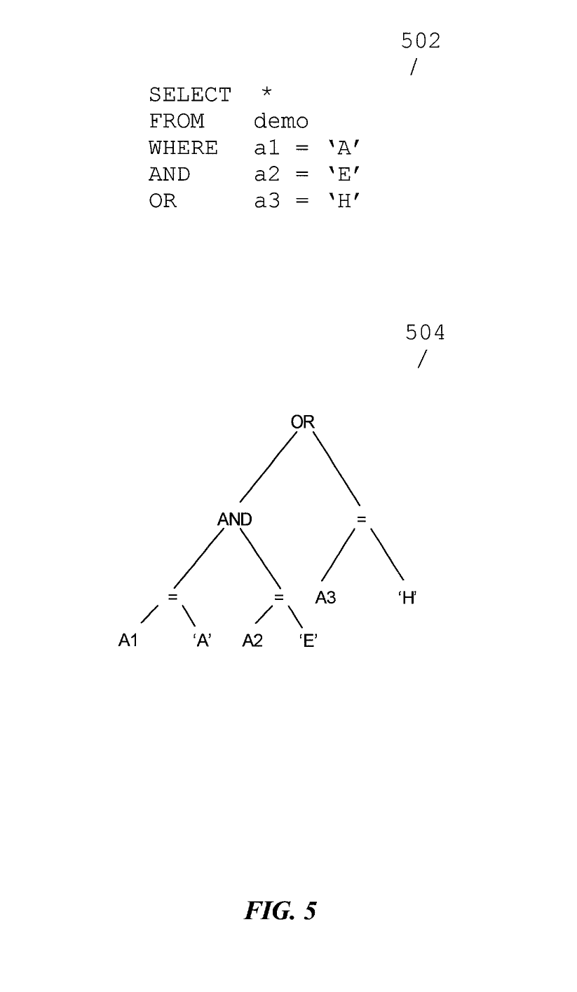

After all of the individual bitmaps are constructed, one for each column referenced in the predicate, the bitmap combination process begins. Individual bitmaps are combined together by ANDing or ORing the bitmaps, as directed by the parse tree, which is derived from the predicate. A parse tree for the sample predicate is illustrated in FIG. 5. Unlike prior art, there is no limitation or restriction that all bitmaps must be ANDed together, or all ORed together. The present invention is a universal technique, in that this technique lacks any requirement or restriction that could disallow using this invention for any particular query. After the BCP completes, a single bitmap exists, referred to as the “Global Bitmap” for this discussion, representing the combined ANDed and ORed bitmaps from the parse tree.

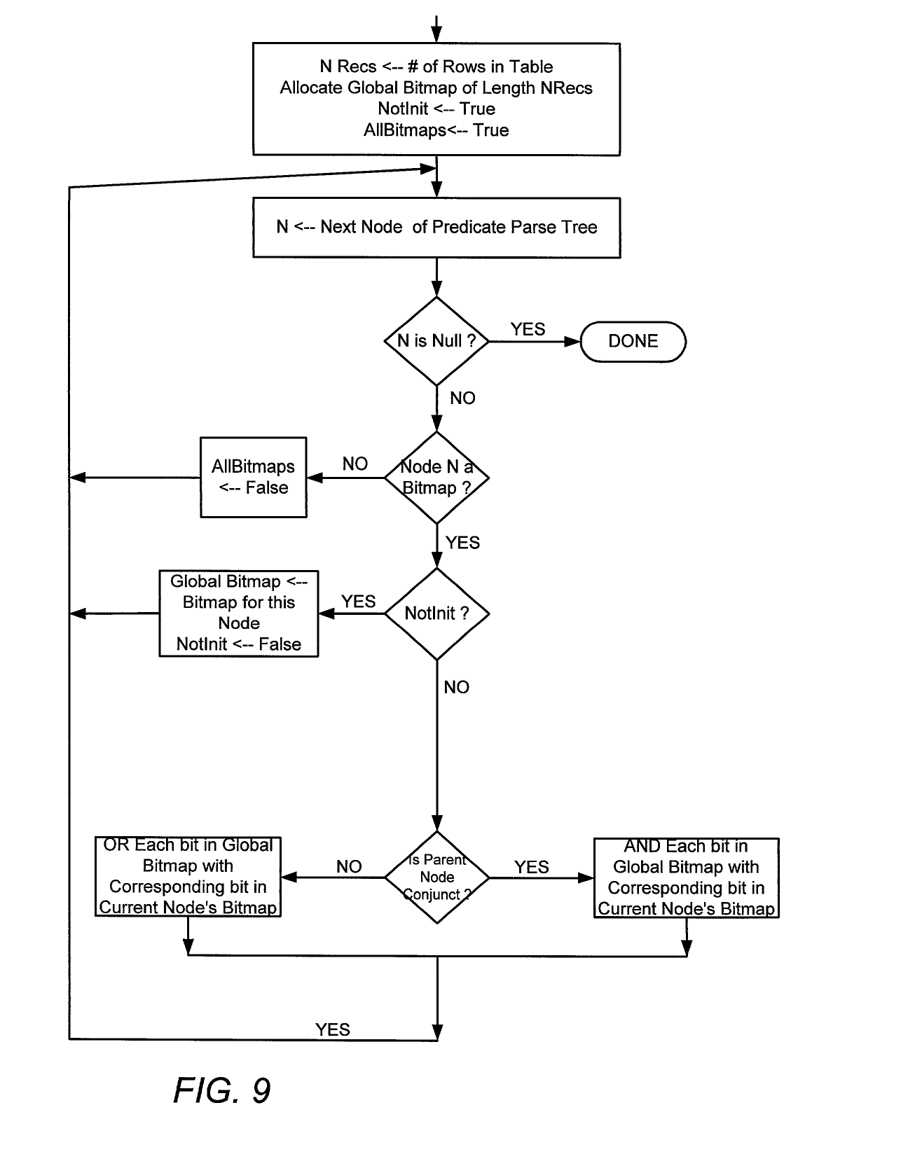

FIG. 9 is a block diagram illustrating the bitmap combination process. The BCP is used when multiple indexes 400 exist.

In conventional systems, no index combining has been supported for these access techniques. Prior art has attempted to solve this problem, but has limitations and restrictions on how and when indexes can be combined. The prior art illustrates indexes with multiple columns, and combinations within a single index are accomplished by either AND or OR. Use of both AND and OR combinations within a single index are not provided for, significantly restricting the usefulness of the technique. Most notably, prior art describes certain combinations within multi-column indexes. To prevent the combinatorial explosion of indexes in the database, the preferred embodiment of the current invention utilizes only single column indexes. Another benefit of this specification is that the requirement in the prior art to scan and combine within an index is eliminated.

The following represents a query 502 that selects all rows from a DEMO table when the value of column A1 is “A”, the value of column A2 is “E”, and the value of column A3 is “H” (FIG. 5):

SELECT*FROM demo WHERE a1=‘A’ AND a2=‘E’ OR a3=‘H’

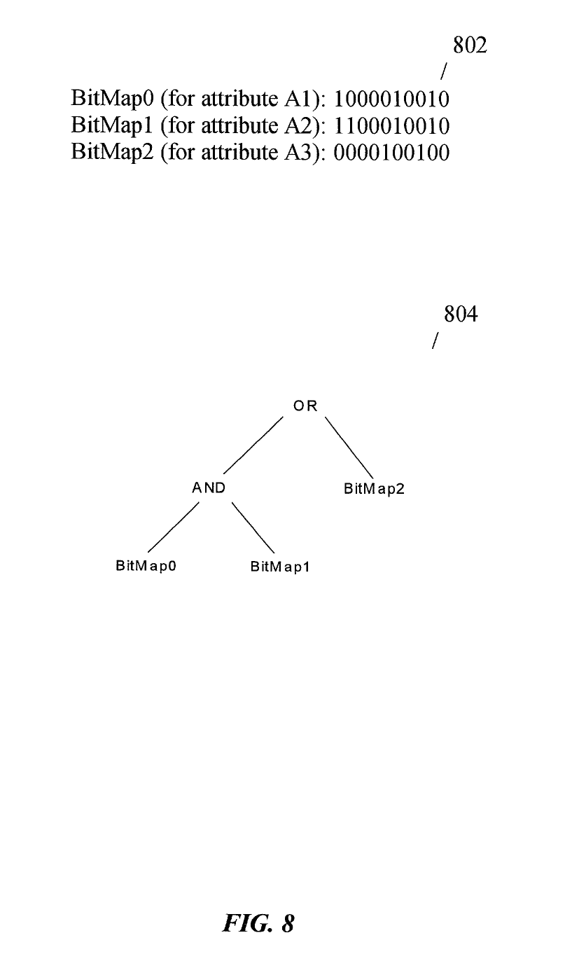

A parse tree 504 for the WHERE clause is illustrated also in FIG. 5. Begin by depth-first searching the parse tree. The first expression (a1=‘A’) has an index on column A1. Search the list of distinct values in the index of column A1 for the desired value ‘A’. If found, create a dynamic bitmap, as illustrated in FIG. 7. This yields a bitmap which looks like “1000010010”. Replace the expression (a1=‘A’) in the parse tree with the newly created bitmap. As the traversal of the parse tree continues each expression visited contains an indexed attribute. A bitmap is generated for each expression and is substituted into the parse tree. After the entire parse tree is traversed, the final parse tree 804 looks like FIG. 8. FIG. 8 also illustrates the contents of the resulting bitmaps 802 for each indexed column in the query.

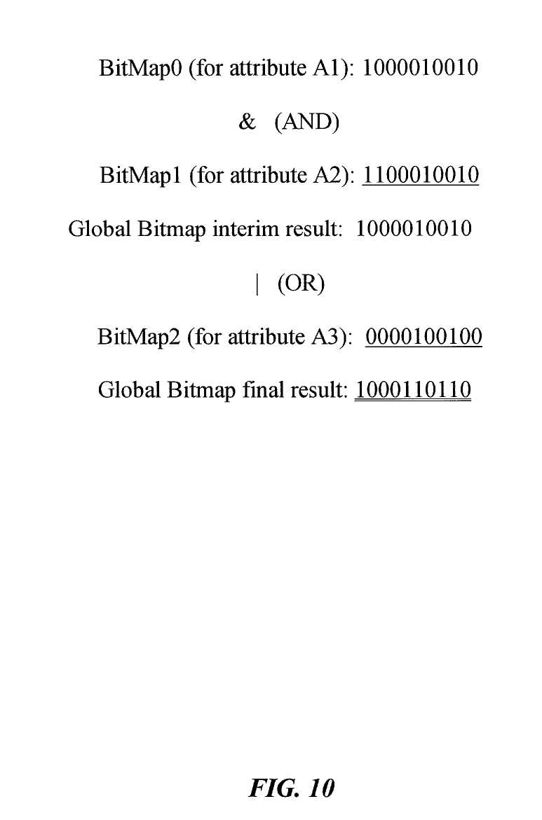

After the parse tree is edited to contain the dynamic bitmaps, a final traversal of the parse tree is required. As the tree is traversed, each dynamic bit map encountered is evaluated with one of the logical operators AND or OR, whichever connects the nodes of the parse tree. FIG. 10 illustrates the dynamic bitmap ANDing or ORing operations on the parse tree of FIG. 8, resulting in the Global Bit Map.

The final Global Bitmap value of our example is 1000110110, indicating that we will retrieve five rows from the partition with PID values 1, 5, 6, 8, and 9.

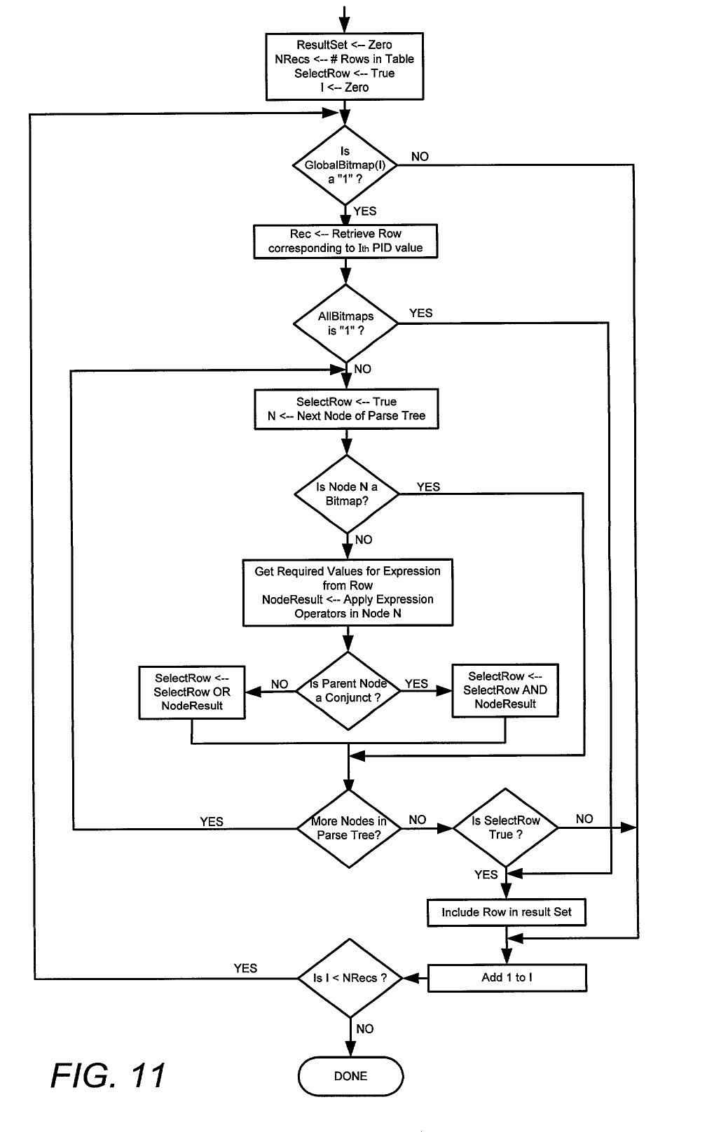

Once the preprocessing for the query is completed, the retrieval operation is very fast. FIG. 11 illustrates a flow diagram for the retrieval algorithm for this invention.

Notice that the best case occurs when all referenced columns contain indexes. In this case, the parse tree 504 need not be evaluated at all during retrieval. In cases where some of the referenced columns do not have indexes constructed, the nodes where bitmaps have replaced the expression are not evaluated, and are simply treated as TRUE values. Significant processing is still eliminated since those nodes that contain bitmaps are not evaluated during retrieval.

The preferred embodiment of the present invention constructs an inverted list index for each of the columns in the DEMO table. Those skilled in the art will recognize that other index constructions can be applied to this process also. When other than PID values are maintained in the index, a hash calculation can convert any other index value to the necessary relative offset required for this technique.

The embodiment of the present invention is particularly advantageous in that it provides significant improvement in memory utilization. During multiple bitmap generation and population, a single index is loaded into memory, the bitmap is generated and populated, and the index is unloaded from memory. Only a single index is in memory at any time, with each index loaded and unloaded in turn until all the required bitmaps are constructed.

The preferred embodiment constructs a single column index on each column of the database table. This technique is still valid when the set of columns are partially indexed. As illustrated in the flowchart diagram of FIG. 11, when a table is partially indexed, retrieved rows require a subsequent scan of the non-indexed columns referenced in the query to ensure their qualification.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of executing a query to access data stored on a data storage device connected to a computer, comprising the step of:
while accessing one or more indexes to retrieve partition invariant designators (PIDs), applying predicates in the query to select corresponding indexes.

2. The method of claim 1, further comprising the step of identifying indexes on columns corresponding to the predicates in the query.

3. The method of claim 1, further comprising the step of constructing dynamic bit maps for each identified column.

4. The method of claim 1, further comprising the step of replacing predicate expressions with the constructed bitmaps.

5. The method of claim 1, further comprising the step of creating a global bit map by traversing the predicate parse tree and combining dynamic bit maps by the logical AND and OR operations.

6. The method of claim 1, further comprising the step of accessing each row with a global bitmap multiple index technique.

7. An apparatus for executing a query to access data stored on a data storage device connected to a computer, comprising the step of:
while accessing one or more indexes to retrieve partition invariant designators (PIDs), applying predicates in the query to select corresponding indexes.

8. The apparatus of claim 7, further comprising the step of identifying indexes on columns corresponding to the predicates in the query.

9. The apparatus of claim 7, further comprising the step of constructing dynamic bit maps for each identified column.

10. The apparatus of claim 7, further comprising the step of replacing predicate expressions with the constructed bitmaps.

11. The apparatus of claim 7, further comprising the step of creating a global bit map by traversing the predicate parse tree and combining dynamic bit maps by the logical AND and OR operations.

12. The apparatus of claim 7, further comprising the step of accessing each row with a global bitmap multiple index technique.

13. An article of manufacture comprising a storage program medium readable by a computer and embodying one or more instructions executable by the computer to perform method steps for executing a query to access data stored on a data storage device connected to a computer, the method comprising the step of:
while accessing one or more indexes to retrieve partition invariant designators (PIDs), applying predicates in the query to select corresponding indexes,

14. The article of manufacture of claim 13, further comprising the step of identifying indexed predicates in the query.

15. The article of manufacture of claim 13, further comprising the step of accessing the rows with an inverted list access technique.

16. The article of manufacture of claim 13, further comprising the steps of accessing each index with a multiple index technique.

17. The article of manufacture of claim 13, where in the multiple index technique comprises the step of performing any combination of AND and OR operations on the indexes.
